(19) United States
(12) Patent Application Publication
(10) Pub. No.: US 2005/0256698 A1
(43) Pub. Date: Nov. 17, 2005

(54) Method and arrangement for translating data

(76) Inventor: Ari Becks, Helsinki (FI)

Correspondence Address: YOUNG & THOMPSON, 745 SOUTH 23RD STREET, 2ND FLOOR, ARLINGTON, VA, 22202, US

(21) Appl. No.: 10/507,144

(22) PCT Filed: Mar. 14, 2003
(86) PCT No.: PCT/FI03/00195

§ 371 Date: Sep. 9, 2004

(30) Foreign Application Priority Data
Mar. 20, 2002 (FI) 20020532

(51) Int. Cl. G06F 17/28

(52) U.S. Cl. 704/2

(57) ABSTRACT

The invention relates to a method and arrangement for classifying the data of an input data flow containing elements by using a knowledge base containing segments. The invention is particularly suited for translating languages. In the method, the processable part of the input data flow is read, divided into elements, and the processable part of the input data flow is divided into segments, so that each segment contains one or several elements. The elements of the processable part of the input data flow are analyzed, and on the basis of the analysis results there is produced a segment specific classification. The segment classification is compared with the classifications of the knowledge base segments, and equivalent segments are associated with each other. Thereafter there is reported the classification result, which consists of a number of knowledge base segments associated with the input data flow to be processed.

In general the invention relates to the classification of data and to the translation or conversion of data into another form that corresponds to the original form. In particular, the invention relates to the translation of languages.

For automatically translating natural languages, there are at present applied mainly two different techniques: machine translation and translation memory techniques. The material to be translated is generally called the input data flow, and said input data flow contains elements that can be identified. In the case of natural languages, the input data flow thus contains clauses and/or sentences, and the elements to be identified are words together with their possible prefixes and suffixes.

In the machine translation technique, the input data flow elements are analyzed according to a precisely defined set of rules. On the basis of the analyzed elements and by means of thousands of parsing rules programmed in the system, there is produced a parsing tree corresponding to the original clause or sentence, said parsing tree describing the codependence of the elements, as well as the dependence of said elements on other subtrees. For instance in the sentence “the cat walks” the element “the cat” is interpreted as the subject, which is dependent on the predicate “walks”. Said dependence relations are defined according to simplified rules, by proceeding from general rules to more detailed ones; for instance in this exemplary sentence, there is first observed a whole sentence constituting said one clause. The clause contains a predicate and a so-called nominal phrase. Said nominal phrase contains a subject and possible adverbials describing the subject. The subject of the clause is a singular noun in the nominative case, and the predicate is a verb in present singular. The produced parsing tree is then transformed into a parsing tree structure in the target language by means of separate transformation rules. After various steps, from the target language parsing tree structure there is generated a unit compiled of elements, said unit conforming to the structure of the clause or sentence according to the target language. Consequently, in order to produce a translation, there must be used at least three different sets of rules for producing, converting and generating the parsing trees, as well as a number of separate sets of analysis and generation rules or other corresponding mechanisms.

In the translation memory technique, the elements are not analyzed, but whole clauses or sentences from the input data flow are compared with element strings contained in a database as a character string comparison. If a similar character or element string is found, its translation is a target language character or element string associated with said string, and it is further produced as a response to the translation request of the input data flow. Systems utilizing the translation memory technique are most effective when various versions of the same text are retranslated, or when the texts to be translated contain identical clauses. Among the prior art techniques, translation memory is a fairly effective and versatile method for eliminating routine work. However, translation memories are not capable of giving a sufficiently accurate translation for clauses that deviate from the earlier translation, but the translator must edit the text always when it contains a new untranslated clause.

Machine translation technique can be applied in a so-called example-based machine translation, EBMT, where the basic idea is that an input sentence is translated by imitating the translations of similar types of ready-made examples. In example-based machine translation, the end result is thus attempted to be produced by combining elements of two different translations—by combining their parsing trees into a parsing tree that corresponds to the input data flow. Other known methods for alleviating the problems of the traditional machine translation technique are memory-based machine translation, analogy-based machine translation and case-based machine translation.

Statistical translation systems are based on the probability of the occurrence of words in the final translation. For instance, equivalents can be looked up in source language sentences and translated sentences, whereafter there is calculated the probability whether the original word is translated by one or two words, or whether it is altogether omitted in the translation. On the basis of this procedure, there are generated translation rules.

There are also known various systems based on restricted languages or sublanguages. However, their usage is strictly disciplined, because the input given by the user must conform to precisely defined rules. From the part of the user, this requires a special capacity and willingness for adaptation. On the other hand, in this kind of a restricted system a well-trained user achieves a nearly ideal result, and the user's help is generally not needed in the translation step.

Machine translation according to the prior art requires the programming of complicated sets of rules and semantics in order to find out the syntactical-connections of single words. In addition, this presupposes heavy programming and typically also interpretation by professionals. The application of example-based, memory-based, analogy-based and case-based machine translation often requires the performance of substeps that are difficult to realize. There are needed parsing trees for both the source language and the target language, in order to find out the equivalent tree elements of the respective sentences. This sets its own requirements to the form in which the information is presented, and the generated tree structures are always troublesome to realize and to use.

If the translation memory system cannot produce a translation for the user's input, it either offers alternative results, among which the user may choose the one that he/she wants, or it may ask the user to feed in the correct translation. Often the translator changes the structure of the translated sentence so much that only the translation equivalent of a whole sentence or clause is saved in the translation memory system. For teaching translation systems, there is typically needed a large number of final translations of the correct type. The drawback of the translation memory technique is its incapability of translating completely new sentences that were not translated before. There have been attempts for solving this problem by connecting known translations to new inputs, among others by making use of neural networks and statistical probabilities. The results have not, however, been promising, because translation memories are not capable of creating an accurately correct result on the basis of a resembling clause, but generally they copy the closest translation equivalent of an input clause as such for the final translation.

Commercially the products that apply the translation memory technique have been more successful than those applying the machine translation technique, because the latter require heavy processing, and thus the devices are typically either too slow or too expensive. One of the drawbacks in the commercialization of both techniques is the huge amount of work required in customizing the systems for new fields of operation, or in adapting the systems along with the development of the structures and vocabulary of a language.

The central problems behind the existing solutions are the efficiency and rapidity required of the machines, as well as the coverage of the system, i.e. the question how large a part of the translations is sufficiently good. In addition, these two are mutually connected. In principle a translation system should be able to translate billions of possible clauses that are created of various different combinations of tens of thousands of words. In example-based systems, this immense amount of alternatives is attempted to be controlled by saving a lot of examples, each of which can be used in many texts to be translated. For instance 10,000 examples, each of which is suited in 10,000 units to be translated, are capable of processing 10 000²=0.1 billions of potential clauses to be translated. In addition, in example-based systems there can be applied segmentation, i.e. the input to be translated can be divided into smaller segments, in which case the number of various combinations is smaller. On this basis, all the problems of example-based translation systems can be grouped for instance into the following four subgroups:
1. Number of examples. The translation system must be able to effectively manage a large number of examples and be able to rapidly search for suitable examples in large databases. This can be done by traditional translation memories, but not by machine translation systems using parsing trees or other representation forms that are more complicated than the text form, and not by example-based translation systems using corresponding techniques.
2. Generalization, search and matching of examples. One example must be suitable in many units to be translated (i.e. in a clause or part of a clause in the source language), the search for a suitable example from the database must take place rapidly, and the matching must be effective. Translation memories cannot do this, because they match the target unit only by text comparison, and are not capable of generalization. On the other hand, many example-based systems are capable of matching the same example in many different units to be translated by applying language technology. There the matching often is a multistep process using methods that are troublesome from the computational point of view, slow and complicated searches and restrictive heuristics, which means that they have poor scalability, i.e. the subproblem 1 is not solved.
3. Segmentation and combining of segments. If the text is translated word by word, the number of required examples is small, but the translation quality is extremely poor. If the size of the example (segment) is a clause or a sentence, a high-quality translation can generally be made, but the number of required examples rises up to billions (without matching—see subproblem 2). The number of required examples can be essentially reduced by using shorter segments than a clause. In that case the combining of segments becomes a new problem, and the proportion of inaccurate translation is increased. Even the use of a whole example clause or sentence does not always ensure a correct translation, because the correct interpretation of a clause/sentence may also require a context external to the clause or the chapter, or a semantic world model. A particular interpretation is required for instance when translating poetry. Depending on the applied generalization technique (subproblem 2), it may be easier to perform a “safe” segmentation. On the other hand, this increases the risk of a wrong translation.
4. Editing of the translation equivalent. If an example-based translation system only uses translation examples and their translation equivalents in text form, without segmentation, it is not necessary to edit the translation equivalent for a source language translation equivalent. If “safe” segmentation is used (subproblem 3), the translation equivalent can be created by combining the translations of the segments. If, on the other hand, there is used generalization (subproblem 2), or combining of short segments, the editing of the translation equivalent can be extremely troublesome.

By using known methods, the solving of all said subproblems at the same time has not succeeded, i.e. the system as a whole does not work. Translation memory systems solve the subproblems 1 and 4, but having no means to solve the subproblem 2, they lack the capacity to generalize. Researching example-based translation systems suggest possible patterns for solving the subproblem 2. For example the known translation program ReVerb (Collins, B., Cunningham, P., Veale, T., An Example-Based Approach to Machine Translation, Proc. of AMTA conference, October 1996, pp. 1-13) attempts to solve the subproblems 2 and 4 by generalizing examples by means of sentence analysis and by taking into account, when choosing the example, the editability of the translation equivalent. However, the complexity of the search and matching mechanism of said program, as well as the knowledge base of a few hundreds of examples, do not seem to be scalable in order to solve the subproblem 1. As for Pangloss (Brown, R. D., Example-Based Machine Translation in the Pangloss System, Proceedings of the 16th International Conference on Computational Linguistics, August 1996), it uses the hybrid model based on a text-based translation memory solution in the subproblem 1, the generality of which has been increased by using, for instance in the translation of dates, matching templates that identify and translate all dates. This model is fairly safe with respect to the subproblem 4, but its generalization capability (subproblem 2) remains rather slight, because all inputs cannot be translated. Therefore Pangloss uses a separate machine translation system for translating the rest of the inputs and for achieving a sufficient degree of generalization. The product that has been most successful commercially, i.e. Trados (http://www.trados-com), as a translation memory solves the subproblem 1 and tries to apply neural calculation for solving the subproblem 2. Here it does not, however, succeed, because neural calculation is not sufficient for solving the subproblem 2, and what is more, the subproblem 4 remains unsolved as well as the subproblem 3. In general it can be said that not one of these systems is capable of utilizing segmentation, with the exception of mainly Pangloss, where an average segment has the length of about three words for those inputs that it can process.

The object of the invention is to produce an efficient and flexible method and arrangement for classifying data and for further translating said data. Another object of the invention is to produce a translation arrangement that is easily adapted in new types of input data flows and structures.

This object is achieved so that data is processed in segments of suitable sizes by efficient methods of analysis. On the basis of the analyzing results, each segment obtains an unambiguous classification that can be used extremely efficiently for comparing segments and as the search key for large knowledge bases. Owing to said efficiency, the size of the knowledge base as well as the number of examples can be further increased, which improves both coverage and quality.

The invention is characterized by what is set forth in the characterizing parts of the independent claims. Preferred embodiments of the invention are described in the dependent claims.

According to a preferred embodiment of the invention, the translation of an input data flow into another form takes place step by step. In the method according to a preferred embodiment of the invention, there are used methods, known as such, for segmenting the input data flow, i.e. for dividing it into parts. Feasible segmentation methods are for instance the segmenting of the input data flow by means of punctuation, as clauses, phrases or by means of an intermediate word, for example by cutting the segment after the next word succeeding the word ‘and’, or before words that begin a subordinate clause. According to a preferred embodiment of the invention, there is applied a segmentation method where the division of the input into segments is carried out so that the created segments are found as comprehensively as possible among the segments already contained in the knowledge base.

According to a preferred embodiment of the invention, the input data flow is first attempted to be translated by using as little resources as possible, for instance by means of translation memory technique. Typically at least part of the input data flow is translated directly and rapidly. The remaining part of the input data flow is subjected to a light analysis, where each of the elements contained in the input data flow is given an analysis result. In the present application the term, while referring to a single element, is analysis result, and an analysis result relating to a whole segment is called classification. Classification is obtained on the basis of the analysis results, for instance by catenating, i.e. by combining the element analysis results and the intermediate symbols added therebetween into a uniform character string. Said segment classification is compared with the segment classifications contained in the knowledge base by using an efficient index or database search. As a result of the search, from the knowledge base there are returned those segments that have the same or nearly the same classification as the segment of the input data flow. Among these segments from the knowledge base, there is chosen, according to certain rules, one segment that best corresponds to the input data flow segment. The chosen segment can be for instance the one that has most similar elements as the input data flow segment to be translated.

As a translation result, from the knowledge base there is returned the equivalent segment that is best associated with the corresponding input data flow segment. Those input data flow segment words that did not occur in said best equivalent segment are translated separately by using a known technique, for instance by generating word by word a suitable inflection for the equivalent element found in a dictionary. The classification and segment comparison with the knowledge base segments according to the invention produces good results efficiently even with a fairly small knowledge base.

The method according to the invention is remarkably different from the prior art machine translation technique, because in the invention, there is for example not created a parsing tree from the input data flow according to a grammar or a set of rules. Neither is it necessary to program rules in the method according to the invention. In addition, according to the invention the input data flow elements also are compared with the knowledge base elements as such, whereas in known machine translation techniques, elements are always processed as analyzed.

The method according to the invention differs from translation memory techniques and example-based translation systems by offering a solution to all four problems groups of example-based translation systems. Classification created on the basis of the analysis result of the input segment to be translated serves as a search key, by which in the knowledge base there is looked up the source language segment of the example translation to be applied (solves subproblems 1 and 2). The search is extremely efficient, because indexing and database techniques can be applied instead of complicated tree comparisons and activation arrangements. Linkage to the target language segment of the example translation edits the translation equivalent by a fairly safe method (solves the major part of the subproblem 4). After the subproblems 1 and 2 have been solved better than in the methods known at present, the size of the knowledge base can be increased remarkably without essentially reducing the efficiency, which further improves the coverage of the method. Therefore in the knowledge base there can be added both short and long segments even of the same examples. The quality of the translations is ensured by using as long segments as possible, these being safer (3 and 4), at the same time as the short segments ensure generalization and coverage better than for instance the neural method or dictionary matching. Thus segmentation can be utilized by employing a segment size that is suitable in the situation in question (subproblem 3).

In addition to translating both text-form natural languages and formal languages, preferred embodiments of the invention can also be used in several areas applying data classification and conversion. In addition to the processing of text-form input data flow, a preferred embodiment of the invention can also be used for interpreting speech. When the translation is made from one programming language to another, the translation process is naturally much more disciplined and syntax-oriented.

The method according to the invention has a higher performance than the prior art methods, because the response time is essentially better than in the known solutions. In addition, the methods according to the invention are very adaptable, i.e. by using them, correct result flows are obtained in a larger part of the cases than before, and at an essentially faster rate than before. Owing to said efficiency, also the knowledge base size and the number of examples can be increased, which further improves the coverage. Moreover, owing to the efficiency, the method need not use additional heuristics or restrictions that could in fact deteriorate the performance—one example is the restriction in the segmentation to the subtrees of the parsing tree only, or an exceptional treatment of predicates in the search structures. However, the method does not prevent said heuristics or other additions from being applied, when they are useful. Apart from translating, the method can easily be generalized to the use of other applications, such as programming language conversions and multichannel publications.

The invention and its preferred embodiments are described in more detail below with the accompanying drawings, where

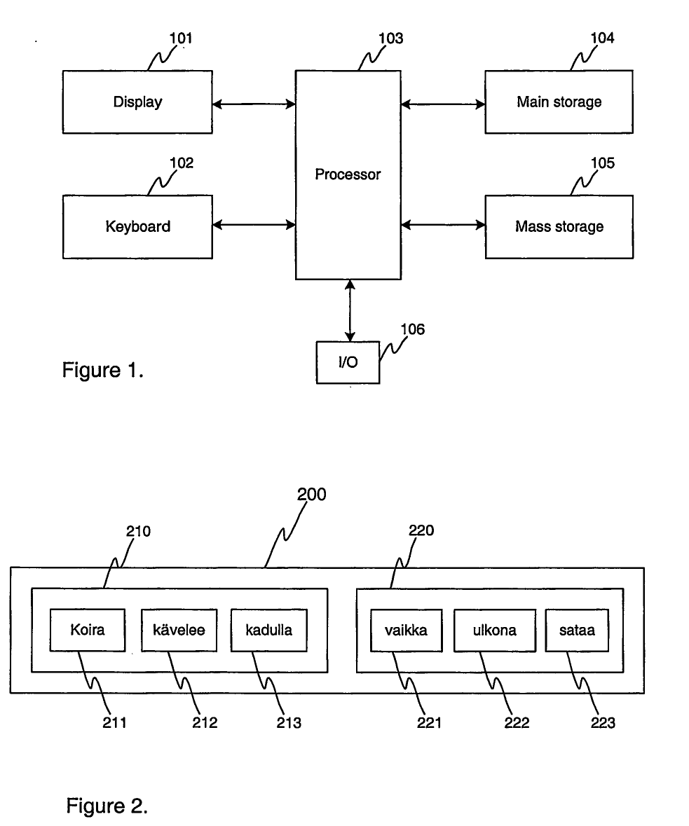

FIG. 1 is a block diagram illustrating an arrangement according to a preferred embodiment of the invention,

FIG. 2 illustrates a processable part of an input data flow according to a preferred embodiment of the invention,

FIG. 3 illustrates the structure of a part of a knowledge base according to a preferred embodiment of the invention,

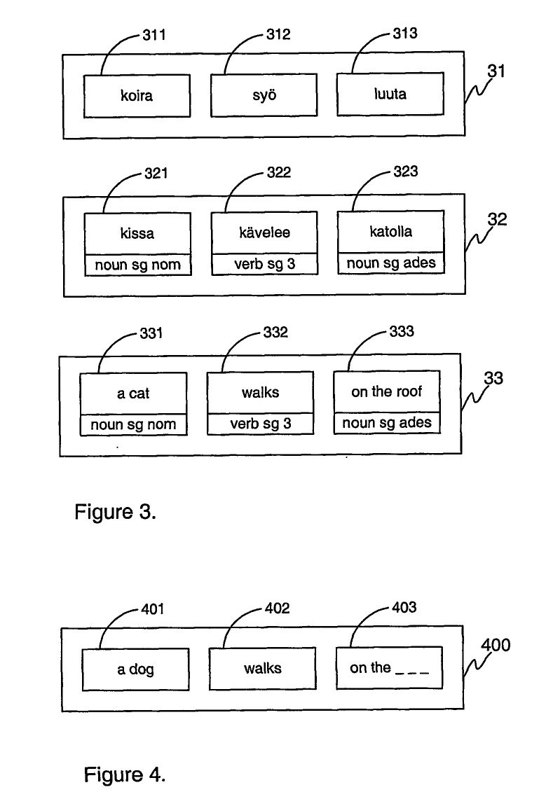

FIG. 4 illustrates a part of an output data flow according to a preferred embodiment of the invention,

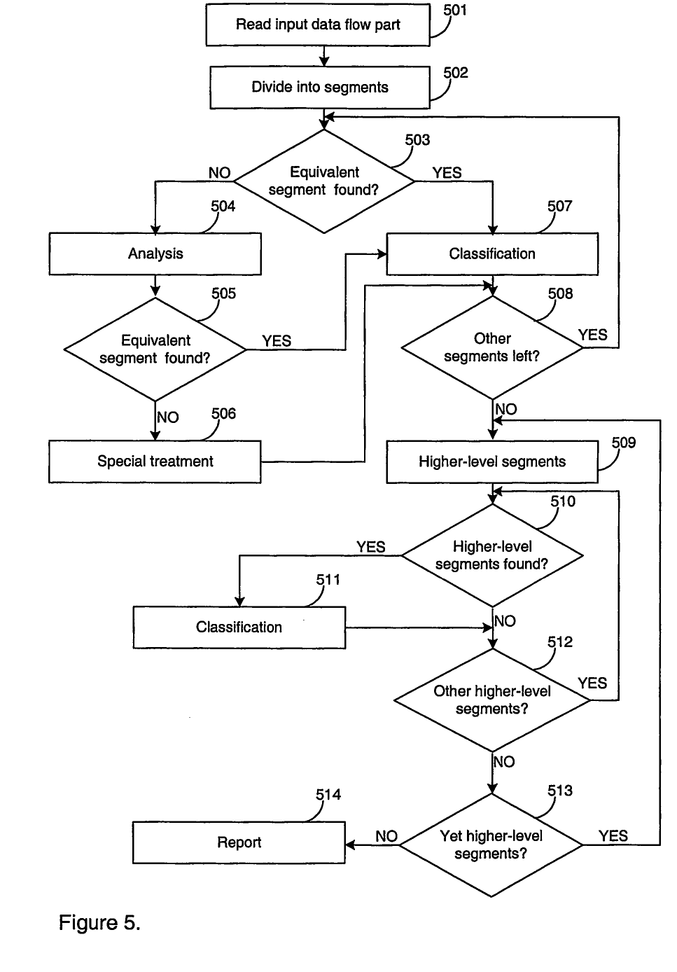

FIG. 5 is a flow diagram illustrating a method according to a preferred embodiment of the invention for classifying data,

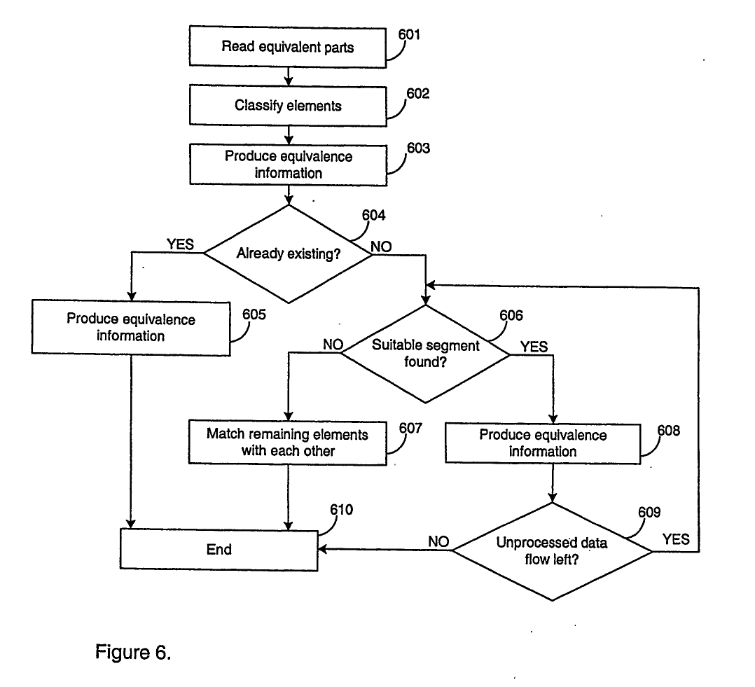

FIG. 6 is a flow diagram illustrating an expanding of the knowledge base according to a preferred embodiment of the invention, and

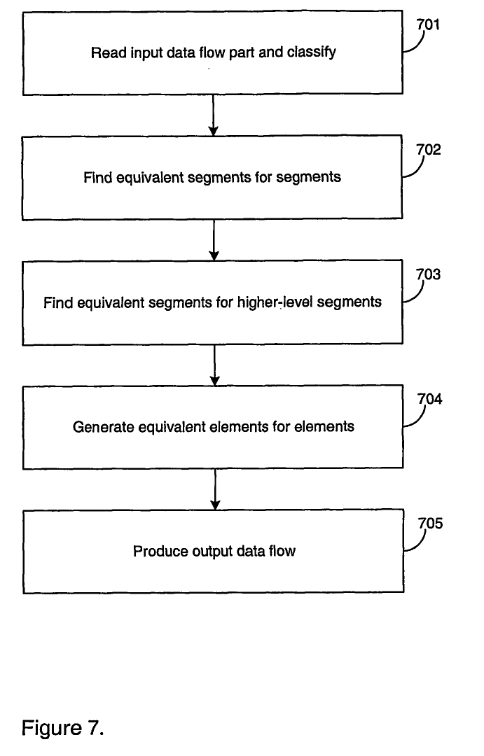

FIG. 7 is a flow diagram illustrating a translation of data according to a preferred embodiment of the invention.

FIG. 1 shows an arrangement according to a preferred embodiment of the invention. The display 101 and keyboard 102 serve as an interface for the user. In the mass storage 105 there are stored knowledge bases and their indexes, as well as the employed programs and rules. In the main storage 104 there is stored the part of the input data flow and the search index that is being processed at any particular time. In addition, the arrangement includes a processor 103 for processing data, and I/O interfaces 106, through which the arrangement can be accessed from the outside.

On the display 101, various results and/or steps of the process can be shown for the user. By means of the keyboard 102, the user can input in the arrangement, apart from the input data flow proper, for instance suggestions of equivalents for such words and sentence structures that the system cannot translate. All data shown on the display 101 and inputted through the keyboard 102 is processed in the processor 103. Through the I/O channels connected to the processor 103, the system can also be in contact with other systems and users, as well as transmit and receive input and output data flows. Consequently, the arrangement according to the invention can be used in various locations, and also by intermediation of a telecommunications connection.

In the main storage 104, there is located that part of the input data flow that is being processed. In addition, in the main storage 104 there are located the segments of the input data flow to be processed. The input data flow part to be processed is divided into parts, i.e. segments, according to certain rules that shall be dealt with later in this application. In the mass storage 105 of the system, there is located a knowledge base containing the segments and their equivalent segments. A separate database can also be provided for the elements and their equivalent elements. Said element database can correspond to a traditional electronic dictionary containing word by word equivalents—or, according to each preferred embodiment of the invention at hand, the elements can be for instance mathematical expressions or commands of formal languages or parameters. The mass storage 105 also contains various processing rules, such as segmentation rules, on the basis whereof the processable part of the input data flow is divided into segments. In addition, the mass storage 105 contains transformation rules for instance for changing word order between a segment and its equivalent segment, as well as the necessary programs, for example the analysis and generation programs required for processing the input data flow. By means of the analysis program, analysis results are produced for the elements of the input data flow. As for the generation program, it produces the element for the output data flow by means of the analysis result. The arrangement according to FIG. 1 is typical for the arrangement according to the invention, but for a person skilled in the art it is obvious that depending on the embodiment in question, the system can be compiled in some other way, too. The arrangement can be located in a PC (personal computer) or on a network server, or the various parts of the arrangement can be physically located in different places, as long as the connections therebetween are sufficiently fast.

FIG. 2 illustrates a processable part 200 of an input data flow according to a preferred embodiment of the invention, which part 200 is thus typically stored in the main storage for the duration of the processing. In this embodiment, the input data flow is natural language, and the part 200 of the input data flow to be processed at a time is typically a clause or a sentence. Said part 200 to be processed is divided into elements 211, 212, 213, 221, 222, 223, which in the case of natural languages are generally words provided with their possible prefixes and/or suffixes. An indefinite or definite article preceding the word typically belongs to the same element with the word itself.

In FIG. 2, the elements 211, 212, 213, 221, 222, 223 of the part 200 of the input data flow to be processed are divided into two segments 210, 220. In this case the segmentation is carried out by identifying the element “vaikka” (“although” in English), which now belongs in the list of those words that start a new segment. Similar lists generally occur in the literature dealing with natural language. The segments can be composed of one or, as is the case in the drawing, of several elements. Segmentation is carried out according to certain rules advantageously stored in the mass storage, which rules can be based for instance on certain easily recognizable words, or on the mutual equivalence between the processable part of the input data flow and the contents of the knowledge base. Some feasible segmentation rules are described in more detail for example in the patent publication FI 103,156. For example, certain segmentation rules can be applied for the Finnish language. In a typical solution the chosen segment is the longest equivalent segment from a knowledge base or from a phrase dictionary. When as many elements as possible are processed at the same time, classification becomes more efficient, and the translation-related problems in combining segments and editing translations can be better avoided. Often a segment is cut at a punctuation mark or word that begins a subordinate clause or a phrase. Segmentation can also be carried out according to the instructions and choices of the user. In addition, a segment can be restricted on the basis of the type or features of the text, for example so that successive bold-face words are processed as one segment. Likewise a string of several unidentified elements can be selected as a segment.

Naturally segmentation rules are language-specific, and there are some variations between languages. As a general rule suiting nearly all natural languages, it can be considered that the chosen segment is one that already exists in the knowledge base. In addition, if a segment located in the middle or in the end of the processable input data flow is identified according to a rule, the preceding element string and the following element string can be treated as separate segments. In the case of formal languages, the elements are typically character strings or single commands. Segments can be distinguished for instance so that they comprise commands and their parameters, or a segment can end in a line feed command or other employed character, character string or special character.

FIG. 3 illustrates a part of a knowledge base according to a preferred embodiment of the invention. The knowledge base contains two saved segments: segment 31 containing elements 311, 312, 313, and segment 32 containing elements 321, 322, 323. The elements 321, 322, 323 of the segment 32 are analyzed, and the results of the analysis are written underneath the element. In this exemplary case of a natural language, on the basis of the analysis the element 321 “kissa” (“a cat”) is a noun, singular (sg), nominative case (nom). The element 322 “kävelee” (“walks”) is analyzed to be a verb in the third person singular (sg 3). The element 323 “katolla” (“on the roof”) is a noun, singular (sg), adessive case (ades). Here the natural language has been subjected to a lexical or a morphological analysis by some known effective method. The advantage of the present method is that the generation of a translation equivalent for words that are not already found in the knowledge base is carried out successfully on the basis of morphological markers. As an alternative, for instance syntactic or semantic rules can be applied. In the case of formal languages, the rules can be based on for example on the formal representation of the language, and when dealing with matrix elements, the analysis can be based on the matrix norm, on the brightness of the image represented by the matrix, or on the three first coefficients of the cosine transformation representing the matrix. Although distinctive analysis results are generated for the elements according to the invention, parsing trees are not created.

The segment 33 of FIG. 3 is an equivalent segment of the knowledge base. Here the figure shows an equivalent segment for the segment 32 of the knowledge base. On the basis of the knowledge of equivalence between said segments 32 and 33, the element 331 corresponds to the element 321, the element 332 corresponds to the element 322 and the element 333 corresponds to the element 323. The analysis results of the equivalent elements are not necessarily the same between different languages, and neither is their order or number. Typically equivalent segment or association information between segments contains order information that tells in which word order, or more generally in which element order, the elements of a corresponding segment can occur. Said order information is not illustrated in FIG. 3. There may also be several equivalent segments, also within one pair of languages. In that case one of the equivalent segments generally is the most optimal, which may mean for instance the most general, the most common or the most recommendable equivalent segment in the context in question. When producing the translation, other alternative equivalent segments can also be used. In the case of several different equivalent segments, the association information must also contain information that tells which equivalent segment each order information points to. For instance in a Finnish segment, the association information pointing to an English equivalent segment may contain order information, according to which the English equivalent for the first element of the Finnish segment is the first element of the English segment, the English equivalent for the second element of the Finnish segment is the third element of the English segment, and the English equivalent for the third element of the Finnish segment is the second element of the English segment. Between respective Finnish and German segments, the order information pointing to the German equivalent segment of a corresponding Finnish segment may be such that the first Finnish element obtains no equivalent at all, the equivalent for the second Finnish element is the fourth German element, the equivalent for the third Finnish element is the third German element, and in addition to these, the equivalent segment includes two other elements at the beginning. When dealing with formal languages, the order information is essential, and it is important to associate the functionally corresponding elements of languages with each other.

Let us now observe how the first part or segment 210 of the input data flow 200 illustrated in FIG. 2, i.e. “koira kävelee kadulla” (“a dog walks on the street”), is translated into English by means of the knowledge base illustrated in FIG. 3 and according to a preferred embodiment of the invention. First the segments of the input data flow 200 are compared with the knowledge base segments. In this exemplary case, the elements are words of a natural language, and they are in this comparison treated as segment-size uniform element strings. This kind of string can be formed in many different ways, for instance simply by combining the segment elements, or by placing a predetermined mark between the elements. From the point of view of the invention, it is essential that the segment of the input data flow can be efficiently compared with the knowledge base segment, i.e. that the segments are of the same form. For efficient comparison, there can be used for instance known indexing techniques or indexing and disk processing optimization mechanisms offered by data management systems.

The first segment 31 of the knowledge base does not correspond to the segment 210 of the input data flow 200. These segments have the same first element 211, 311, but here the comparison is carried out for the segments as a whole. Neither does the second segment 32 of the knowledge base correspond to the segment 210 of the input data flow 200, although the second elements 212 and 322 of these segments are likewise the same. The comparison of a input data flow segment with the segments of the knowledge base can be made more effective by using known indexing and search methods. If in the knowledge base there is not found a segment that is a complete equivalent element by element, the elements 211, 212, 213 of the segment 210 of the input data flow 200 are analyzed, and an analysis result is obtained for each element. Thereafter the segment is further observed as a classified entity. Now we observe the analysis results in a uniform, segment-size string formed in a predetermined manner, i.e. the segment classification, which is then compared with corresponding analysis result strings, or classifications, of the knowledge base. As a result of said comparison, the equivalent for the segment 210 of the input data flow 200 in the knowledge base is the segment 32. For the segment 32 of the knowledge base, there is looked up an equivalent segment 33 from the knowledge base, and the elements 321, 322, 323 of the knowledge base segment 32 that was found on the basis of the analysis results are compared with the corresponding elements 211, 212, 213 of the input data flow 200. Among said elements, the mutually completely equivalent elements are the ones in the middle, i.e. the input data flow consists of elements, among which an equivalent is found for the one in the middle. Equivalent elements for the first and last input data flow elements are obtained for the output data flow for instance by looking up an equivalent element for the input data flow element from the database of elements and equivalent elements, and by generating a precise equivalent element form according to the analysis result by means of a separate generating program. Depending on the embodiment, the above described translation steps can be carried out for each segment of the processable part of the input data flow from beginning to end, or for the whole part of the input data flow, each step segment by segment. In the previously described embodiment, the described translation steps are next carried out for the second segment 220 of FIG. 2.

A part of an input data flow according to a preferred embodiment is illustrated in FIG. 4. In FIG. 4, there is on the basis of classification found a segment corresponding to the input data flow, and an equivalent element 402 for the input data flow element is found from the knowledge base. For the elements 401 and 403, there were found corresponding analysis results from the knowledge base, and on the basis of said results, it is found out that there is no information of said stem words, i.e. nouns, but that the form is the same as the one defined in the analysis results of the equivalent elements. This means that the affixes of the word, i.e. prepositions and postpositions, are the same as those of the form corresponding to the analysis result. Typically said missing part is asked from the user, but it can also be looked up for example in an electronic dictionary. The segment knowledge base and the equivalent element knowledge base illustrated in FIG. 3 are mutually symmetrical, wherefore they can be used in two directions, i.e. the input data flow can have the form of equivalent elements, and the output data flow can have the form of knowledge base segments. Similar bidirectionality can also be realized between several languages, both in parallel and in serial form. Parallel languages are mutually equal in standing, and the source and target languages of the translation can be chosen among them. In a serial arrangement, the third language can serve as a so-called relay language, through which the translation between the other two languages is always made.

FIG. 5 illustrates a method for classifying data according to a preferred embodiment of the invention. In block 501, from the input data flow there is read the part to be processed at a time, which part may, for instance when classifying a natural language, be for example a data search request, a clause, a sentence or a command along with the respective parameters. From the processable input data flow part there are separated the elements which here, according to the example under observation, are words plus their affixes, or character strings. In block 502, the processable input data flow part is grouped into segments according to predetermined rules stored in the memory unit, or according to definitions set by the user. A segment may contain one or several elements. In step 503, there are compared input data flow segments, containing one or several elements, as a whole with the segments already stored in the knowledge base. If a segment with completely identical contents is not found, there is moved to block 504, where the elements are analyzed either by a mechanism provided inside the system, or by a separate analyzer. For each element, there is produced an analysis result, which in the case of a natural language is typically based on lexical or morphological analysis, and in the case of a formal language on syntactic analysis.

In step 505, there are segment by segment compared the analysis results of the input data flow elements, i.e. segment classification, with the classification of the segments stored in the knowledge base. In case an equivalent segment is not found even on the basis of classification, there is carried out a special treatment in block 506. The special treatment is a predetermined operation or procedure where for instance a new knowledge base segment can be created of an input data flow segment; where each element can be treated as one segment; or where new segmentation can be performed. Thereafter moving on to step 508. If the analysis results compared in step 505 correspond to each other, the performance moves on to block 507, to which the process also proceeds from block 503 in case the input data flow and output data flow segments are equivalents. In block 507, with the input data flow segment there is associated the equivalent segment already stored in the knowledge base.

In step 508 it is checked whether the processable part of the input data flow still contains segments that have not been processed. If there are still unprocessed segments left, the performance moves over to the beginning, to block 503, in order to deal with all of the segments contained in the processable part of the input data flow. Otherwise there is moved to block 509 in order to observe whether the now classified segments are included in some higher-level segment. This kind of situation may occur for instance when a classifier according to a preferred embodiment of the invention is used when translating natural or formal languages, or when converting currencies. The higher-level segments clarify and simplify the operation for example when currency symbols are shifted between different languages over structures containing several numeric elements, when a formal language has nested loop structures, or when the natural language is German, and the segment contains a German clause with a structure that does not correspond to the structure of the target language. In the exemplary case of the German language, the created higher level can be a segment where the first subsegment contains a given conjunction, the second subsegment contains segments according to a given classification—which segments contain several unidentified elements—and the last subsegment contains an element classified as a verb. Thus several resembling situations can be generalized and there can be created a generic segment describing them on a higher level of the knowledge base—without especially paying attention to what exactly are the elements of the clause. This further reduces the size of the knowledge base and makes comparisons faster.

In block 510, there is observed a string composed of several segments and studied whether the above treated segments or the segment string belong or match in a hierarchically higher-level segment. A higher-level segment can be composed of one or several lower-level segments. If higher-level segments are found, there is looked up a classification result 511 for them, too, in a corresponding manner as for the lower-level segments. If a corresponding higher-level segment is not found in the knowledge base, the remaining classification is the subsegment string. If higher-level segments were not created or classified when the classification was performed in block 511, in block 512 it is observed whether the input data flow part to be processed still contains segments that can be associated as some other higher-level segment. If these kinds of segments are found, the operation is continued from block 510. When even higher-level segments formed of segments are not found, there is still checked in step 513, whether the found higher-level segments form further third-level segments. If further higher-level segments are found, the operation is continued from block 509. Typically the lower-level segments contain elements, the next higher-level segments contain segments, and possibly elements, too. The higher we rise on the segment level, the more the segments of natural languages contain given contractual standard conditions, such as for example the context of a text paragraph. In the case of formal languages, the segments can be for instance commands with their parameters, or language clauses, which are typically separated by using a marker. Thus a higher-level segment may contain structural information, for instance knowledge of a loop, nested loops or subprograms. The higher the segment level in question, the more the description of formal languages approaches algorithm description.

When the hierarchical segments are dealt with and classified, in block 514 there is reported the classification of the processed input data flow part as a string of one or several hierarchical segments of the higher level. Thus the data classifier according to the method illustrated in FIG. 5 associates with the processable part of the input data flow a string of possibly hierarchical segments contained in the knowledge base. When processing hierarchical structures, the order information of the hierarchical subsegments is typically located in the higher-level segment. Said order information defines the order of the lower-level segments, i.e. for instance in the case of a natural language, it defines the word order, and in the case of a formal language, it defines the parameters of a command or subprogram call, their type, number and mutual order.

In the embodiment of FIG. 6, there is illustrated how new segments and equivalent segments are generated in the knowledge bases by means of learning, i.e. by expanding the knowledge base without user interaction. In step 601, there are read two corresponding parts of the input data flow. The performing of the method according to FIG. 6 requires that there is available a two-part input data flow that is known to contain the same data in two different representation forms that are mutually complete equivalents. In block 602, there are classified the read corresponding input data flow parts for instance by using the classification method specified in connection with the embodiment illustrated in FIG. 5. In block 603, each input data flow part is stored in the knowledge base, and equivalence information for the stored input data flow parts is produced by means of the knowledge base, so that there are looked up elements corresponding to the segments already contained in the knowledge base, as well as equivalents in classification results. The now described typical comparison criteria to be used when segmenting a new input data flow can also be used in many other preferred embodiments of the invention. A primary choice is a segment that is found in the knowledge base and includes, for each element, exactly the same input data flow element. In that case there is chosen the longest possible corresponding segment of the knowledge base, and it is associated with the input data flow part under observation. Next let us observe the analysis results. If several segments in the knowledge base have an analysis result that is equivalent to the input data flow part under observation, there is chosen the segment that has as many elements as possible that are equivalent to the input data flow part under observation. If several knowledge base segments also have the same number of equivalent elements, there is chosen the function that is most suitable in the situation and application in question—for instance the segment may be chosen according to usage frequency, so that the chosen segment is the one that has been used most often. The segment may also have a semantic classification, i.e. for instance a definition for field of operation that defines the segment as belonging to a given field, such as paper technology or biotechnology. In addition, each element may have a corresponding semantic classification. The segments may further contain a so-called marker, i.e. priority that tells for example that a given segment is an official translation, or that a given segment should not be used as a segment in the output data flow of the translation, but only when performing the classification of the input data flow.

In block 604 it is tested whether one of the input data flow parts to be processed already is contained as a whole in the knowledge base. If a block equivalent to the input data flow part is found in the knowledge base, the knowledge base also includes information of the segments contained in this kind of input data flow part. According to the found segment division, also the input data flow part is divided into segments in block 605. In addition, in block 605 there are looked up translations, i.e. equivalent segments and their equivalence information by searching from the knowledge base equivalences for known segments and classifications, whereafter the processing ends in block 610. If a block corresponding to the whole input data flow part is not found in block 604, the processing continues in block 606.

In block 606, the still unprocessed input data flow parts are compared with the knowledge base segments by applying any suitable segment size, and from the knowledge base there is searched a segment that best corresponds to the unprocessed input data flow. If in the knowledge base there is found a segment that corresponds to a segment of the input data flow part to be processed, in block 608 there is looked up a corresponding segment and equivalence data for said input data flow segment. On the basis of these, the translation proper i.e. the equivalent segment is found in the knowledge base. In block 609 it is checked whether there still are unprocessed elements in the input data flow part to be processed. Block 606 is resumed in order to process the rest of the input data flow part, until equivalent segments are generated or found for all input data flow segments. If a sufficiently good segment is not found in neither part of the knowledge base in block 606, there is moved to block 607. In step 607, the remaining input data flow parts are matched with each other, respective segments are generated and equivalent segment information is produced. Thereafter performance ends in block 610.

According to a preferred embodiment of the invention, the automatic translation proper of the data is carried out in the way illustrated in FIG. 7. First there is read the input data flow part in block 701. The input data flow part to be processed also is classified in block 701, possibly as a string of hierarchical segments, for example according to the classification method illustrated in FIG. 5. In block 702, for each segment of the processable input data flow part there is looked up an equivalent segment from the knowledge base of equivalent segments. Some of the segments may also form a higher-level segment. Next there are looked up equivalent segments for the found higher-level segments from the knowledge base in block 703. If equivalent segments are not found for the higher-level segments, the obtained result is a string of lower-level segments. The equivalent segments and further the equivalent segment elements are arranged in an order according to the order information. The order information may be located either in the segments or in the association information, i.e. in the equivalence information that associates the knowledge base segments with their equivalent segments. As for this equivalence information, it may be located either in the segments or separately from those. Equivalent segments for such elements for which equivalent segments are not yet found are generated in block 704. Said equivalent segments can be looked up in the equivalent segment database, or they can be generated as a result of the analysis results by using a suitable generator. The generator may utilize for instance a dictionary-type database of equivalent segments in order to find the stem of the equivalent segment and to convert it into a form required by the analysis results. Finally in block 705 there is produced an output data flow part corresponding to the processable input data flow part, as a string of elements contained by the equivalent segments and of the generated equivalent segments, which are inside the segments arranged according to the order information. When the translation is ready, it may further be added in the knowledge base.

However, the size of the knowledge base is often desired to be kept fairly small, because then the searching is carried out more rapidly and the data structure does not take up a lot of space but can be fitted in the main storage. Particularly when dealing with knowledge bases containing hierarchical segments, it is useless to store all possible content alternatives, because they are found on the basis of existing information more effectively than by searching in a large knowledge base.

The exemplary case described in the present application deals with the translating of a natural language, but it is obvious that the method according to the invention can likewise be applied in the classification and recognition of for example speech, images and formal languages. Moreover, the elements to be processed can be for instance numbers, matrixes, character strings, machine-language commands or parameters. The translation and classification of formal languages is extremely important when different forms of information and data from different sources should be used and converted in a standard form.

More generally, when looking up information and performing inquiries it is important that also such found segments that are interpreted as fairly close equivalents are absorbed in the output data flow. In that case the employed criteria may be for example the semantic proximity, already mentioned in previous, where meanings are studied. Depending on the application at hand, it may be advantageous to alternatively observe either the lexical, morphological or syntactic interpretation. If the desired classification or translation cannot be produced, it is possible, according to a preferred embodiment of the invention, to perform for example classification or another subfunction, or the whole translation, by using a corresponding arrangement and method according to a preferred embodiment of the invention that either has an existing telecommunications connection or to which said connection can be made. Another corresponding system may for example primarily deal with the segments or elements of a given special field. In addition, several arrangements may have in common, stored in one memory unit, for instance segmentation rules, exception rules and transformation rules, as well as listings of semantically, lexically, morphologically and syntactically equivalent elements and segments.

1-29. (canceled)

30. A method for processing the data of an input data flow containing elements by using a knowledge base including segments, the method including steps of:
reading a processable part of the input data flow and dividing it into elements,
grouping the processable part of the input data flow into segments of which each segment contains one or several elements,
analyzing the elements of the processable part of the input data flow and on the basis of the analysis result, producing a segment specific classification,
comparing the classification of segments of the input data flow is compared with the classifications of segments of the knowledge base, and a knowledge base segment is associated with the input data flow segment having the corresponding classification, and
reporting the result that consists of a number of knowledge base segments associated with the processable part of the input data flow.

31. A method according to claim 30, wherein at least one segment contains at least two elements, and that the segment specific classification is defined on the basis of the analysis result of at least two of said elements.

32. A method according to claim 30, wherein the element analysis results are catenated in order to establish a segment-specific classification.

33. A method according to claim 30, wherein the classification of the input data flow segment serves as a search key when searching for a knowledge base segment with the same classification.

34. A method according to claim 30 so, that after grouping into segments, there is performed a step where the processable part of the input data flow is compared segment by segment with the knowledge base segments, and the mutually equivalent segments are associated with each other, whereafter the analysis step is performed only for those segments for which an equivalent knowledge base segment was not found.

35. A method according to claim 34, wherein if one input data flow segment obtains, when comparing with the knowledge base segments, several equivalent segments, one of these is chosen by applying at least one of the following criteria:
there is chosen a segment with most input data flow elements,
there is chosen a segment that the user indicates,
there is chosen a segment that has been used most frequently,
there is chosen a segment with a semantic classification that corresponds to the classification of the respective part of the input data flow,
there is chosen a segment, the semantic classification of the elements of which corresponds to the classification of the respective part of the input data flow.

36. A method according to claim 30, wherein in the knowledge base, there are included segments with different lengths and partly similar contents, by means of which the processable part of the input data flow is grouped into segments, optimally case by case.

37. A method according to claim 30, wherein the grouping of the input data flow into segments is carried out by at least one of the following methods:
a chosen segment is a segment already contained in the knowledge base that is an equivalent for the input data flow part by its elements or its classification,
a segment is defined according to the instructions of the user,
a language unit is made into a segment,
a phrase is made into a segment,
a segment is cut at a punctuation mark,
a segment is cut at given, listed intermediate words,
a segment is formed of a remaining part of the input data flow, when the segments found by other means are removed from the input data flow part.

38. A method according to claim 30, wherein the segments form hierarchical structures where a given higher-level segment contains information of given lower-level segments, and that the method comprises a step of associating with the processable part of the input data flow higher-level segments of the knowledge base, said segments containing lower-level segments of the knowledge base, associated with the input data flow segments.

39. A method according to claim 30, wherein the input data flow segment is subjected to a special treatment according to given instructions in a case where a corresponding segment classification is not found in the knowledge base.

40. A method according to claim 30, wherein the analysis to be performed for the elements is a morphological analysis, and that as the result of said analysis, there are generated certain features describing said elements.

41. A method according to claim 30, wherein in order to translate data into a target language, for the target segments there are looked up equivalent segments from the knowledge base of two or more languages, and as the result flow, there is generated a number of equivalent segments containing equivalent elements.

42. A method according to claim 41, wherein for those input data flow elements for which equivalents are not found in the knowledge base, there are generated equivalent elements according to given analysis results connected to the knowledge base elements and/or by means of a separate element-generating generator.

43. A method according to claim 41, wherein the output data flow produced when translating data contains elements of equivalent segments and separately generated elements as a segment string, so that the internal order of the equivalent elements inside each segment is defined on the basis of the order information contained in the equivalent segments.

44. A method according to claim 41, wherein the output data flow to be produced when translating data contains elements of equivalent segments and separately generated elements as a segment string, so that the internal order of the equivalent elements inside each segment is defined by an equivalence information between the segments and their equivalent segments.

45. A method according to claim 30, comprising, in order to form a knowledge base, steps of:
reading two mutually corresponding input data flow parts and dividing those into elements,
classifying those parts of the input data flows that should be processed at a time,
for the processable part of the input data flow, looking up segment division, equivalent segments and equivalence information between these on the basis of the segments contained in the knowledge base and on the basis of their classification, and
matching the unsegmented parts of the processable input data flows that are left without equivalent segments with each other and forming into segments, and for said segments, generating equivalent segments and their mutual equivalence information.

46. A method according to claim 45, wherein the equivalence information, equivalent segments and segment division of the segments are generated on the basis of previously in the knowledge base stored segments and/or their classification.

47. An arrangement for processing data of an input data flow containing elements, the arrangement including
memory units for storing the segment-containing knowledge base, look-up indexes, information and an processable part of the input data flow,
means for reading the input data flow,
means for dividing the input data flow into elements,
means for grouping the input data flow into segments containing elements,
means for analyzing the input data flow elements and for producing a segment specific classification on the basis of the analysis results,
means for comparing the input data flow segment classification with the knowledge base segment classifications and for associating equivalent segments with each other, and
means for reporting the segment classification.

48. An arrangement according to claim 47, including also means for comparing the input data flow segments with the knowledge base segments.

49. An arrangement according to claim 47, including also means for generating equivalent segments containing equivalent elements as a string that forms an output data flow.

50. An arrangement according to claim 47, wherein the arrangement has a connection to an element-generating generator in order to generate elements on the basis of the analysis results.

51. An arrangement according to claim 47, wherein the memory units contain segmenting information for dividing the input data flow part into segments, and order information for defining the respective order of the elements in the input data flow segments.

52. An arrangement according to claim 47, wherein the memory unit contains a knowledge base for storing segments, elements, classifications, equivalent segments and equivalent elements.

53. An arrangement according to claim 47, including I/O interfaces for transmitting and receiving input and output data flows and for establishing connections with other systems and/or users.

54. An arrangement according to claim 47, including means for comparing the whole processable part of the input data flow with knowledge base segments, with any segment size whatsoever.

55. An arrangement according to claim 47, including means for reading and processing mathematical expressions.

56. An arrangement according to claim 47, including means for reading and processing formal languages.

57. An arrangement according to claim 47, including
means for reading natural languages,
means for dividing natural languages into elements, said elements being words with their affixes,
means for grouping a natural language into segments, said segments being units containing words,
means for classifying a natural-language processable section on the basis of lexical, morphological, syntactic or semantic analysis, and
means for generating equivalent segments containing equivalent words.

58. An arrangement according to claim 57, having a telecommunications contact with a corresponding arrangement in order to perform a subfunction.
